(19) United States
(12) Patent Application Publication
(10) Pub. No.: US 2018/0232840 A1
(43) Pub. Date: Aug. 16, 2018

(54) GEOSPATIAL CLUSTERING FOR SERVICE COORDINATION SYSTEMS

(71) Applicant: Uber Technologies, Inc., San Francisco, CA (US)

(72) Inventor: Yifang Liu, Burlingame, CA (US)

(21) Appl. No.: 15/433,980

(22) Filed: Feb. 15, 2017

(51) Int. Cl. G06Q 50/30; G06Q 30/02; G06F 17/30; G06F 7/08

(52) U.S. Cl. CPC G06Q 50/30; G06F 7/08; G06F 17/30241; G06Q 30/0205

(57) ABSTRACT

A service coordination system divides a geographic region into clusters by performing an iterative clustering process that joins locations with similar characteristics. An operational parameter is generated for each cluster, and this parameter is used throughout the cluster. This process results in the generation of clusters that cover areas that have relatively uniform characteristics. As a result, when the same operational parameter is used throughout a cluster, the parameter is appropriate for every location covered by the cluster.

### BACKGROUND

This disclosure relates generally to service coordination systems and more particularly to dividing a geographic region into clusters to join locations with similar characteristics.

Service coordination systems provide a means of travel by connecting people who need rides (e.g., “riders”) with drivers (e.g., “providers”). A rider (e.g., a user) can submit a request for a ride to the service coordination system, and the service coordination system selects a provider to service the request by transporting the rider to their intended destination.

A service coordination system can offer a number of features whose value varies by location. For instance, a service coordination system may charge a different price to riders depending on where their rides started and ended. Similarly, a service coordination system may offer providers an incentive payment to travel to a particular location and offer rides in that location.

A service coordination system divides a geographic region into clusters by performing an iterative clustering process. The region is initially separated into geographic cells, each of which covers a geographic area. Then, cells are clustered by joining locations with similar characteristics. Thus, this process results in the generation of clusters that cover areas that have relatively uniform characteristics. As a result, when an operational parameter of the service coordination system is generated or modified for a cluster, the response within the cluster is expected to generate a similar response by the users within the cluster.

The service coordination system collects location-based data that describes the past behavior of riders and providers in the geographic region. To initialize the clustering process, the service coordination system divides the geographic region into a plurality of cells. In some implementations, all of the cells have the same size and shape. For example, all of the cells are hexagons of the same dimensions. The service coordination system uses the location-based data to generate service coordination metrics for each cell, with each service coordination metric describing a type of rider behavior in the cell, a type of provider behavior in the cell, or some combination of rider and provider behavior. For example, one of the service coordination metrics might be a provider-to-rider match probability that represents the probability that a provider offering rides in the cell is matched to a rider who requests a ride in the cell.

The service coordination system maps the cells to an initial set of clusters. For example, the system maps every cell to a separate initial cluster. The service coordination system generates an initial set of similarity scores between pairs of the initial clusters. For example, the system generates a similarity score for every pair of adjacent clusters (e.g., clusters that share at least one boundary in the region). As another example, the system generates a similarity score for every possible pair of clusters. Each similarity score is a measure of the overall level of similarity between the two clusters in the pair, and each similarity score is generated by combining one or more similarity components. Each similarity component represents a different aspect of similarity between the two clusters. For example, one of the similarity components may represent the similarity in the provider-to-rider match probability values of the two clusters. The similarity scores are saved to an association table that associates each similarity score to the corresponding cluster pair.

Starting with the initial set of clusters, the service coordination system performs an iterative clustering process. In each iteration, the system selects, from the association table, the cluster pair with the similarity score representing the highest degree of similarity. For instance, in an implementation where a lower similarity score represents a higher degree of similarity, the system selects the cluster pair with the lowest similarity score. The system combines the two clusters in the selected cluster pair to create a single new cluster and uses the service coordination metrics of the previous two clusters to generate a set of service coordination metrics for the new cluster.

The system also updates the association table with each iteration. The portion of the table corresponding to the selected cluster pair and similarity score is removed. The system also generates new similarity scores between the new cluster and at least some of the other clusters and adds the new similarity scores, along with the associated cluster pairs, to the association table. Until a stop condition is satisfied, the iterative clustering process repeats with the updated association table.

When the stop condition is satisfied, the iterative process stops and outputs a mapping between each of the initial cells to one of the clusters. The process also outputs a set of service coordination metrics for each cluster. The service coordination system may also generate an operational parameter, such as a transportation value or an incentive value, for each cluster based at least in part on the service coordination metrics for the cluster. For example, if the clusters will be used to generate incentive values, the system can generate an incentive value for each cluster based at least in part on the provider-to-rider match probability of the cluster.

The service coordination system can perform this process to create a different cluster maps for each feature of the system that uses location-specific operational parameters, and the similarity score generated for any given feature can give additional weight to similarity components that are especially relevant to that feature. For example, if a cluster map is being generated for location-based incentive values to be paid to providers, the system gives additional weight to similarity components corresponding to provider sensitivity (which represents the likelihood that a provider will provide a ride for a given incentive value) and the provider-to-rider match probability (which is described above) when generating the similarity score. Giving additional weight to these metrics causes the iterative clustering process to generate a cluster map that has relatively uniform provider sensitivity and provider-to-rider match probability metrics throughout each cluster. Because these metrics are especially relevant to generating an appropriate incentive value, offering the incentive values across clusters generated in this manner results in an incentive value that is appropriate for every location within the cluster.

### BRIEF DESCRIPTION OF DRAWINGS

Figure (FIG. 1 illustrates a system environment and architecture for a service coordination system, according to one embodiment.

FIG. 2A illustrates a block diagram of a similarity score generator, according to one embodiment.

FIG. 2B illustrates an example of how the cluster shape component of the similarity score can be generated with respect to two pairs of clusters, according to one embodiment.

FIG. 3 is a flow chart illustrating a method for generating location-specific operational parameters by dividing a geographic region into a plurality of clusters, according to one embodiment.

FIGS. 4A-4B illustrate an example of dividing a geographic region into a plurality of clusters, according to one embodiment.

FIG. 5 is a flow chart illustrating a method for dividing a geographic region into a plurality of clusters, according to one embodiment.

FIG. 6A is a flow chart illustrating a method for generating an operational parameter for a trip request, according to one embodiment.

FIG. 6B is a flow chart illustrating a method for determining the sensitivity value between an origin location and a destination location, according to one embodiment.

FIG. 7 illustrates physical components of a computer used as part or all of the service coordination system, the rider device, and/or the provider device, according to one embodiment.

### DETAILED DESCRIPTION

FIG. 1 illustrates a system environment and architecture for a service coordination system 130, in accordance with some embodiments. The illustrated system environment includes a rider device 100, a provider device 110, a network 120, and a service coordination system 130. In alternative configurations, different and/or additional components may be included in the system environment. The service coordination system 130 provides coordination services between a number of riders each operating a rider device 100 and a number of providers each operating a provider device 110 in a given region. To provide these services, the service coordination system 130 divides a geographical region into a set of clusters. Each cluster identified by the service coordination system 130 is associated with one or more operational parameters that the service coordination system 130 uses to customize settings for trips including the cluster (e.g., originating, ending, or passing through that cluster). A rider as used herein can refer to a user of rider device 100 and need not be a passenger of a vehicle. A rider device 100 as used herein can refer to any suitable device configured to request services, e.g. programmatically, from the system.

As described herein, a rider device 100 and/or a provider device 110 can be a personal or mobile computing device, such as a smartphone, a tablet, a wearable computing device, a vehicle, or a computer. In some embodiments, the personal computing device executes a client application that uses an application programming interface (API) to communicate with the service coordination system 130 through the network(s) 120.

By using the rider device 100, the rider can interact with the service coordination system 130 to request a transportation service from an origin (e.g., a pickup location) to a destination (e.g., a dropoff location). While examples described herein relate to a transportation service, the travel coordination system 130 can enable other services to be requested by requesters, such as a delivery service, food service, entertainment service, etc., in which a provider is to travel to a particular location.

A rider can make a trip request to the service coordination system 130 to request a trip by operating the rider device 100. As an example, a trip request can contain rider identification information, the number of passengers for the trip, a requested type of the provider (e.g., a vehicle type or service option identifier), the current location and/or the pickup location (e.g., a user-specific location, or a current location of the rider determined using a geo-aware resource of the rider device 100), and/or the destination for the trip.

The provider can interact, via the provider device 110, with the service coordination system 130 to connect with riders to whom the provider can provide the requested service (e.g., transportation). In some embodiments, the provider is a person driving a car, bicycle, bus, truck, boat, or other motorized or non-motorized vehicle capable of transporting passengers or items or capable of providing a service. In some embodiments, the provider is an autonomous vehicle that receives routing instructions from the service coordination system 130. For convenience, this disclosure generally uses a car with a driver as an example provider. However, the embodiments described herein may be adapted for these alternative providers.

A provider device 110 receives, from the service coordination system 130, assignment requests to be assigned to transport a rider who submitted a trip request to the service coordination system 130. For example, the service coordination system 130 can receive a trip request from a rider device 100, select a provider from a pool of available (or open) providers to provide the trip, and transmit an invitation message to the selected provider's device 110. In some embodiments, when a provider device 110 receives an assignment request, the provider has the option of accepting or rejecting the assignment request. By accepting the assignment request, the provider is assigned to the rider, and is provided the rider's pickup location and trip destination. In one example, the rider's pickup location and/or destination location is provided to the provider device 110 as part of the invitation or assignment request.

In some embodiments, the provider device 110 interacts with the service coordination system 130 through a designated client application configured to interact with the service coordination system 130. The client application of the provider device 110 can present information, received from the service coordination system 130, on a user interface, such as a map of the geographic region, the current location of the provider device 110, an assignment request, the pickup location for a rider, a route from a pickup location to a destination, current traffic conditions, and/or the estimated duration of the trip. According to some examples, each of the rider device 100 and the provider device 110 can include a geo-aware resource, such as a global positioning system (GPS) receiver, that can determine the current location of the respective device (e.g., a GPS point). Each client application running on the rider device 100 and the provider device 110 can determine the current location and provide the current location to the service coordination system 130.

The rider device 100 and provider device 110 communicate with the service coordination system 130 via the network 120, which may comprise any combination of local area and wide area networks employing wired or wireless communication links. For example, the network 120 includes communication links using technologies such as Ethernet, 802.11, worldwide interoperability for microwave access (WiMAX), 3G, 4G, code division multiple access (CDMA), digital subscriber line (DSL), etc. in example embodiments. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any format, such as hypertext markup language (HTML) or extensible markup language (XML). In some embodiments, all or some of the communication links of the network 120 may be encrypted.

The service coordination system 130 includes various modules and data stores for providing trip matching services and performing geospatial clustering. In the example shown in FIG. 1, the service coordination system 130 includes a matching module 135, a location-based data store 140, a cell initialization module 145, a cluster generation module 150, a cluster store 160, and a parameter generation module 165. These components illustrate one example of performing geospatial clustering in the context of a service coordination system. In other examples, geospatial clustering may be provided for other systems or uses. In alternative configurations, different and/or additional components may be included in the system architecture. It will be appreciated that a number of components such as web servers, network interfaces, security functions, load balancers, failover servers, management and network operations consoles, and the like are not shown so as to not obscure the details of the system architecture. Additional data stores and services may be further included, e.g., for service coordination, that are also not shown.

The matching module 135 provides trip matching for riders and providers and selects a provider to service the trip request of a rider. The matching module 135 receives a trip request from a rider through the rider device 100 and determines a set of candidate providers that are online, open (e.g., are available to transport a rider), and near the requested pickup location for the rider. The matching module 135 selects a provider from the set of candidate providers to which it transmits an assignment request. The provider can be selected based on the provider's location, the rider's pickup location, the type of the provider, the amount of time the provider has been waiting for an assignment request and/or the destination of the trip, among other factors. In some embodiments, the matching module 135 selects the provider who is closest to the pickup location or would take the least amount of time to travel to the pickup location. The matching module 135 sends an assignment request to the selected provider. In some embodiments, the provider device 110 always accepts the assignment request and the provider is assigned to the rider. In some embodiments, the matching module 135 awaits a response from the provider device 110 indicating whether the provider accepts the assignment request. If the provider accepts the assignment request, then the matching module 135 assigns the provider to the rider. If the provider rejects the assignment request, then the matching module 135 selects a new provider and sends an assignment request to the provider device (not shown) for that provider. In some embodiments, rather than requesting confirmation from the provider device 110, the service coordination system 130 assigns the selected provider to the rider without express confirmation from the provider device 110.

The location-based data store 140 maintains location-tagged data describing the actions of providers and riders as they interact with the service coordination system 130. For instance, the location-based data store 140 stores information about user interactions with the service coordination system 130 and locations associated with those interactions. The interactions may include information describing interactions of users and providers prior to and during each trip. Information about a trip may include the locations and timestamps for several actions, such as: the location and time at which the rider submitted the trip request; the location and time at which the provider was assigned to the rider; the location and time at which the trip began; and the location and time at which the trip ended. In addition, information about a trip may include price and payment information, such as the price paid by the rider for the trip and the payment given to the provider for the trip. Additional modules may also be included in service coordination system 130 to record data in the location-based data store 140 that is not related to any particular trip, such as: the locations and times at which providers are available to take assignment requests; the incentive values (e.g., payments for providing a service at a particular location or area) offered to providers; the locations and times at which prospective riders checked pricing information for a particular location without submitting a trip request; and the pricing information offered to prospective riders.

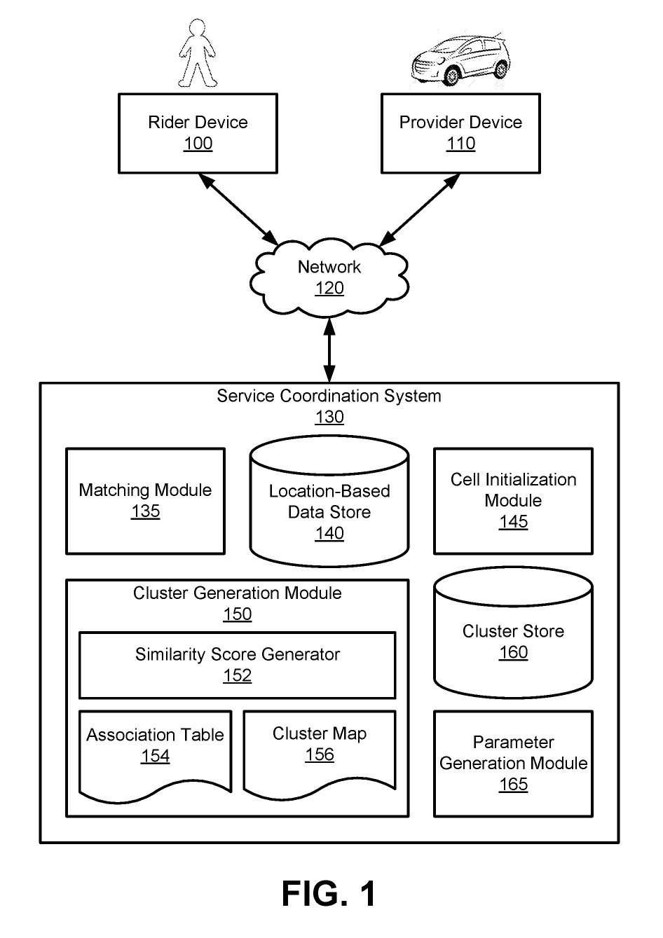

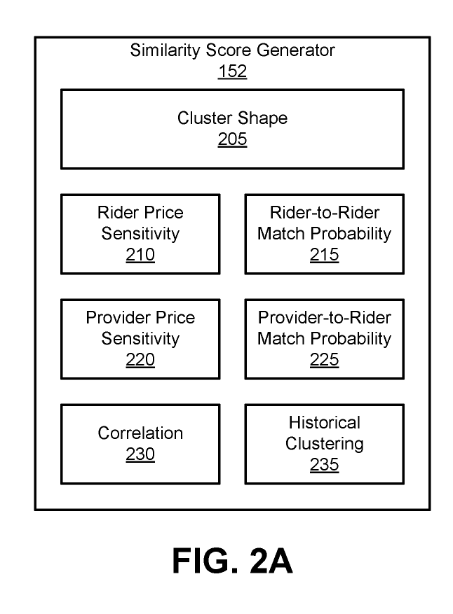

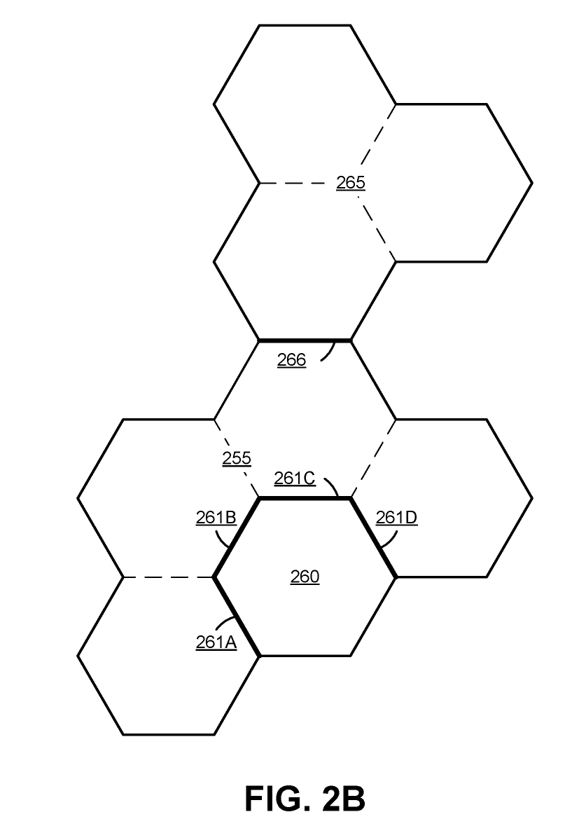

The cell initialization module 145 divides a geographic region into a plurality of cells and generates service coordination metrics for each cell based on located-based data for locations within the cell. As referred to herein, a service coordination metric is a scalar value that quantifies a type of rider or provider behavior within a bounded area (e.g., a cell or a cluster). One example of a service coordination metric is a provider sensitivity metric, which quantifies the likelihood that a provider will become available for assignment requests in a given area when a given incentive value is offered to providers who take assignment requests in that area. In this example, the cell initialization module 145 generates the provider sensitivity metric for a cell by calculating a correlation between the number of providers who are available to take assignment requests in the cell and the incentive value being offered to providers who take assignment requests in the cell. Additional examples of service coordination metrics are described with reference to the similarity score generator 152 of FIG. 2A.

The cluster generation module 150 receives the cells for a geographic region and the service coordination metrics for those cells and generates a cluster map for the geographic region. The cluster generation module 150 includes a similarity score generator 152 that uses the service coordination metrics, along with other metrics, to generate a similarity score that quantifies the degree of similarity between a pair of clusters. The cluster generation module 150 maintains an association table 154 that stores each similarity score in association with the cluster pair for which the similarity score was generated. The cluster generation module 150 also maintains a cluster map 156 that defines the boundaries of each cluster. In one embodiment, the cluster map 156 defines the set of cells making up each cluster, and the boundaries of a cluster are the same as the combined boundaries of the cells making up that cluster. For example. the cluster map 156 is a mapping from each of the received cells to a cluster identifier for the cluster containing that cell. As another example, the cluster map 156 is a two-dimensional array of values, where the position of a value within the array (e.g., the row and column) represents the coordinates of a cell and the value represents an identifier for the cluster containing the cell. In another embodiment, the cluster map 156 defines the boundaries explicitly. For example, the cluster map 156 may be a dataset containing a set of cluster identifiers, a set of GPS coordinates identifying the center of each cluster, and sets of GPS coordinates defining the borders between the clusters (e.g., as geofences).

To begin the clustering process, the cluster generation module 150 generates a set of initial clusters from the cells and stores the initial clusters in the cluster map 156. The similarity score generator 152 generates an initial set of similarity scores between some or all of the cluster pairs, and the cluster generation module 150 populates the association table 154 with the similarity scores. In one embodiment, the association table 154 is implemented as a square matrix, with each row and column representing a cluster. In this embodiment, each cell corresponds to the pair of clusters represented by the cell's row and column (e.g., if the first row represents the first cluster and the second column represents the second cluster, then the cell in the first row and the second column corresponds to the cluster pair formed by the first and second clusters), and the value in each cell is the similarity score for the corresponding cluster pair.

After populating the association table 154 with the initial set of similarity scores, the cluster generation module 150 performs an iterative clustering process. In each iteration, the cluster generation module 150 identifies cluster pair having the similarity score representing the highest degree of similarity (e.g., by accessing the association table 154), and the cluster map 156 is updated to merge the identified cluster pair to create a new cluster. The cluster generation module 150 generates service coordination metrics for the new cluster. The similarity score generator 152 generates new similarity scores between the new cluster and the other clusters (e.g., the clusters that were not part of the identified cluster pair). The cluster generation module 150 updates the association table 154 by adding the new similarity scores and removing any similarity scores associated with the previous two clusters. The cluster generation module 150 performs another iteration with the updated association table 154 until a predetermined stop condition has been satisfied. When the stop condition has been satisfied, then the cluster generation module 150 provides the current cluster map 156 as output.

The cluster store 160 stores one or more cluster maps generated by the cluster generation module 150. The cluster store 160 may additionally store metadata associated with each cluster map, such as the geographic region that the cluster map covers, the feature for which the cluster map will be used, and the weights that were to each similarity component when generating the similarity scores during the clustering process. The cluster store 160 may also store some or all of the service coordination metrics for the clusters in a cluster map. For a given geographic region, the cluster store 160 can store multiple cluster maps, where each cluster map is used for a different feature of the service coordination system 130 within that geographic region.

The parameter generation module 165 generates one or more operational parameters for each cluster in a cluster map. As referred to herein, an operational parameter is any numerical parameter maintained by the service coordination system 130 would benefit from having a value that varies by location. In some embodiments, the parameter generation module 165 generates operational parameters for a cluster based at least in part on the service coordination metrics for the cluster. For example, one of the operational parameters that the parameter generation module 165 generates may be a cluster-specific incentive value to be paid to providers for offering to provide rides in a cluster. In this example, the parameter generation module 165 may generate the incentive value for each cluster based at least in part on a provider price sensitivity metric for the cluster. As another example, another operational parameter that the parameter generation module 165 may generate is a transportation value (e.g., price or rate to be charged to riders for a trip, either to an individual user in the ride, or to a ride including multiple riders) for trips originating or ending in a cluster. In this example, the parameter generation module 165 may generate the transportation value for each cluster based at least in part on a rider price sensitivity metric for the cluster.

FIG. 2A illustrates a block diagram of the similarity score generator 152 shown in FIG. 1, according to one embodiment. As described above with respect to the cluster generation module 150, a similarity score is a value that quantifies the degree of similarity between two clusters in a cluster pair. The similarity score generator 152 operates by generating several similarity components 205 through 235 and combines the similarity components into a single similarity score (e.g., with a weighted sum). In the embodiment shown in FIG. 2A, the similarity score generator 152 can generate up to eight similarity components 205 through 235. In other embodiments, the similarity score generator 152 can generate additional, fewer, or different similarity components.

In one embodiment, a lower similarity score between a pair of clusters represents a higher degree of similarity between the two clusters. The descriptions of the similarity components 205 through 235 provided below are provided with reference to such an embodiment; thus, a similarity component with a lower value will increase the overall degree of similarity between the two clusters. In other embodiments, a higher similarity score between a pair of clusters may represent a higher degree of similarity between the two clusters.

The cluster shape component 205 represents the compactness of the new cluster (e.g., as measured by the perimeter-to-size ratio of the new cluster) that would be created if the cluster pair is combined. In one embodiment, the cluster shape component 205 between a pair of clusters with identifiers A and B is calculated with the following formula:

$$clusterShapeComponent ( A , B ) = 1.0 - min ( 1.0 , \frac{connectivity ( A , B )}{min ( \vert A \vert , \vert B \vert )} ) .$$

In this formula, connectivity(A, B) represents the length of the shared edge between clusters A and B, |A| and |B| represent the spatial size (e.g., the area) of clusters A and B, and “min” represents the minimum function.

FIG. 2B illustrates an example of how the cluster shape component 205 of the similarity score can be generated with respect to two pairs of clusters using the formula provided above. In example shown in FIG. 2B, there are three clusters 255, 260, and 265. The first cluster 255 has a spatial size of four (e.g., four hexagonal cells), the second cluster 260 has a spatial size of one (e.g., one hexagonal cell), and the third cluster 265 has a spatial size of three (e.g., three hexagonal cells). The shared edge between the first cluster 255 and the second cluster 260 has a length of four (e.g., the four sides 261A through 261D), and the shared edge between the first cluster 255 and the third cluster 265 has a length of one (e.g., the side 266).

According to the formula provided above, the cluster shape component 205 between the first cluster 255 and the second cluster 260 has a value of 0:

$$1.0 - min ( 1.0 , \frac{4}{min ( 4 , 1 )} ) = 1.0 - 1.0 = 0.$$

Meanwhile, the cluster shape component 205 between the first cluster 255 and the third cluster 265 has a value of 0.667:

$$1.0 - min ( 1.0 , \frac{1}{min ( 4 , 3 )} ) = 1.0 - 0.333 = 0.667 .$$

The example shown in FIG. 2B demonstrates that this formula yields a lower value for cluster pairs that will yield a more compact cluster if joined. In this example, separate clusters 255, 260, and 265 are shown, in which cluster 255 includes four cells, cluster 260 includes one cell, and cluster 265 includes three cells. In this example, joining the first and second clusters 255, 260 would yield a new cluster with a perimeter of sixteen sides and a size of five cells (a perimeter-to-size ratio of 3.2), whereas joining the first and third clusters 255, 265 would yield a new cluster with a perimeter of twenty-six and a size of seven cells (a perimeter-to-size ratio of 3.7). In an embodiment where this formula is used for the cluster shape component 205, a lower value for the cluster shape component 205 signifies a pair of clusters that have a higher degree of similarity as measured by geographical compactness.

This formula for generating the cluster shape component 205 is advantageous, for example, because it can be implemented in a manner that uses less computing power than other methods of quantifying the compactness of a new cluster. As a result, the clustering process as a whole can be completed in less time. In addition, this formula is based on the shared border between two clusters rather than the entire borders of the two clusters, which can advantageously generate more reliable results for clusters adjacent to the boundaries of the geographic region if the geographic region has boundaries with concave portions.

In other embodiments, the cluster shape component 205 can be generated in a different manner that also quantifies the compactness of the cluster that results from combining a cluster pair. For example, in another embodiment, the cluster shape component 205 for a cluster pair is generated based on the perimeter-to-size of the new cluster that would be generated if the cluster pair is joined. In general, values of the cluster shape component 205 representing more compact clusters are taken to signify a higher degree of similarity. Thus, if the similarity score generator 152 gives weight to the cluster shape component 205 when generating the similarity score, the clustering process will tend to create clusters that are more compact.

Referring back to FIG. 2A, the rider price sensitivity component 210 represents the difference in rider price sensitivity between two clusters. Rider price sensitivity is a service coordination metric that quantifies the relationship between the transportation value for a geographic area (e.g., the price point at which rides are offered in a geographic area) and the likelihood that riders in the area will make a trip request. In one embodiment, a higher value for the rider price sensitivity indicates that riders are more sensitive to ride prices. For example, if a small increase in ride prices in a geographic area leads to a large decrease in the likelihood that riders in the area will make a trip request, then the rider price sensitivity for the area has a high value. Meanwhile, if the same increase in ride prices in a geographic area leads to a smaller decrease in the likelihood that riders in the area will make a trip request, then the rider price sensitivity for the area has a smaller value.

The similarity score generator 152 generates the rider price sensitivity component 210 by calculating a difference in the rider price sensitivity values for two clusters, so the rider price sensitivity component 210 has a lower value between two clusters that have similar rider price sensitivity values. Thus, if the similarity score generator 152 gives weight to the rider price sensitivity component 210, then clusters with similar rider price sensitivity metrics are more likely to be combined.

The rider-to-rider match probability component 215 represents the difference in rider-to-rider match probability between two clusters. Rider-to-rider match probability is a service coordination metric that represents the probability that a matching algorithm is able to match a first rider's trip request to a second rider's trip request. In one embodiment, the matching algorithm matches two trip requests whose origins and destinations permit efficient combination of the requests to a single route for a provider, which advantageously allows a single provider to provide both rides (this kind of arrangement is referred to herein as a shared trip). In one embodiment, the rider-to-rider match probability is associated with the pickup location of the first rider's trip request (e.g., the rider-to-rider match probability for a geographic area is the probability that a first rider making a trip request whose pickup location is inside the geographic area will be matched to a second rider's trip request). In another embodiment, the rider-to-rider match probability is associated with the destination of the first rider's trip request (e.g., the rider-to-rider match probability for a geographic area is the probability that a first rider making a trip request whose destination is inside the geographic area will be matched to a second rider's trip request). In still another embodiment, a first rider-to-rider match probability is associated with pickup location, and a second rider-to-rider match probability is associated with destination, and the two rider-to-rider match probability metrics are used to generate two separate rider-to-rider match probability components 215. In some embodiments, the rider price sensitivity values used to generate the rider price sensitivity component 210 may similarly be associated with pickup and destination locations.

The similarity score generator 152 generates the rider-to-rider match probability component 215 by calculating a difference in the rider-to-rider match probability values for two clusters, so the rider-to-rider match probability component 215 has a lower value between two clusters that have similar rider-to-rider match probability values. Thus, if the similarity score generator 152 gives weight to the rider-to-rider match probability component 215, then clusters with similar rider-to-rider match probability metrics are more likely to be combined.

The provider price sensitivity component 220 represents the difference in provider price sensitivity between two clusters. Provider price sensitivity is a service coordination metric that quantifies the relationship between an incentive value for a geographic area (e.g., the incentive payment offered to providers to provide rides in a geographic area) and the likelihood that providers will offer to provide rides in the geographic area (e.g., by traveling from their current location to the geographic area). As referred to herein, an incentive value can include a fixed payment amount offered to providers for providing a ride originating in a geographic area (which may be regardless of the ride's length or duration) or a payment rate which results in a variable payment amount based on one or both of the rider's length or duration. In one embodiment, a higher value for the provider price sensitivity indicates that providers are more sensitive to incentive payments. For example, if a small increase in the incentive payment offered for a geographic area leads to a large increase in the likelihood that providers will offer to provide rides in the area, then the provider price sensitivity for the area has a high value. Meanwhile, if the same increase in the incentive payment for a geographic area leads to a smaller increase in the likelihood that providers will offer to provide rides in the area, then the provider price sensitivity for the area has a smaller value.

The similarity score generator 152 generates the provider price sensitivity component 220 by calculating a difference in the provider price sensitivity values for two clusters, so the provider price sensitivity component 220 has a lower value between two clusters that have similar provider price sensitivity values. Thus, if the similarity score generator 152 gives weight to the provider price sensitivity component 220, then clusters with similar provider price sensitivity values are more likely to be combined.

The provider-to-rider match probability component 225 represents the difference in provider-to-rider match probability between two clusters. Provider-to-rider match probability is a service coordination metric that represents the probability that a provider offering rides in a geographic area will be matched to a rider's trip request (e.g., via the process performed by the matching module 135).

The similarity score generator 152 generates the provider-to-rider match probability component 255 by calculating a difference in the provider-to-rider match probability values for two clusters, so the provider-to-rider match probability component 225 has a lower value between two clusters that have similar provider-to-rider match probability values. Thus, if the similarity score generator 152 gives weight to the provider-to-rider match probability component 225, then clusters with similar provider-to-rider match probability metrics are more likely to be combined.

The correlation component 230 represents the strength of a correlation between a service coordination metric in a first cluster and a service coordination metric in a second cluster. For example, the correlation component 230 may represent a positive correlation between the number of trip requests in a first cluster and a number of providers offering rides in a second cluster (which indicates that many of the trip requests made in the first cluster are causing providers to travel to the second cluster and then become available in the second cluster). As another example, the correlation component 230 may represent a negative correlation between the number of trip requests with pickup locations in the first cluster and the number of trip requests with pickup locations in the second area (in other words, as more trips originate in the first cluster, fewer trips originate in the second cluster). In this case, it may be advantageous to combine the two clusters because the new cluster that is created may have a steadier rate of trip requests over time. In one embodiment, the correlation component 230 has a lower value when a correlation is stronger (which represents a higher degree of similarity); as a result, if the similarity score generator 152 gives weight to the correlation component 230, then cluster pairs with a stronger correlation are more likely to be combined. Although only one correlation component 230 is shown in FIG. 2A, other embodiments may include multiple positive and/or negative correlation components based on different pairs of service coordination metrics.

The historical clustering component 235 is generated by comparing two clusters to a previous cluster map for the geographic region (e.g., stored in cluster store 160) to determine whether the two clusters were part of the same cluster in the previous cluster map. The value of the historical clustering component 235 represents the extent to which the two clusters were part of the same previous cluster. For example, the historical clustering component 235 may have a value of 0 (representing the highest degree of similarity) if the entirety of both clusters was part of the same previous cluster. As another example, the historical clustering component 235 may have a value of 0.5 (representing a moderate degree of similarity) if half of the first cluster and half of the second cluster were part of the same previous cluster. Giving weight to the historical clustering component 235 increases the likelihood that two clusters that were in the same previous cluster are joined; as a result, the cluster map being generated can be made to look similar to a previous cluster map. This factor may also prevent clustering for areas that may otherwise appear similar. For example, suppose a region includes an urban area that spans a river, and the urban area is part of different states or legal jurisdictions on each side of the river. This example region may include adjacent cells or clusters along both sides of the river. For this example region, prior clusters (or prior maps from other sources) may have never joined the cells due to the river or due to the different legal jurisdictions, and the historical clustering component may account for this historical separation. When modeling this as a factor (e.g., instead of automatically preventing joinder of these cells), these clusters may still be considered to be joined if the regions otherwise have similar characteristics.

After generating some or all of the similarity components 205 through 235, the similarity score generator 152 combines the similarity components 205 through 235 into a similarity score for the cluster pair. In one embodiment, the similarity score generator 152 combines the similarity components 205 through 235 by generating a weighted sum of the similarity components 205 through 235. For example, the similarity score generator 152 performs the following summation over the similarity components 205 through 235:

$$similarityScore ( A , B ) = {\sum }_{i = 1}^{n} {w}_{i} {C}_{i} .$$

In this equation, A and B are the two clusters in the cluster pair, i is an index for the similarity components, n is the total number of similarity components, wᵢ is the weight assigned to the i^{th} similarity component, and Cᵢ is the value of the i^{th} similarity component. In this embodiment, the weights wᵢ are provided as input to the similarity score generator 152 from a human operator, from a separate process executing on the service coordination system 130, and/or from a communication received from a separate computing system.

In other embodiments, the similarity score generator 152 combines the similarity components 205 through 235 with a formula that applies weights to the improvement in the difference between each similarity component and a target value corresponding to the similarity component. For example, the similarity score generator 152 performs the following summation over the similarity components 205 through 235:

$$similarityScore ( A , B ) = {\sum }_{i = 1}^{n} {M}_{i} - {w}_{i} Δ ( {T}_{i} - {C}_{i} ) .$$

In this equation, A, B, i, n, wᵢ, and Cᵢ have the same meaning as in the equation presented above. Tᵢ is a target value for the i^{th} similarity component, and Mᵢ is a maximum (or minimum) value for the i^{th} similarity component. In these embodiments, the target values Tᵢ and the maximum/minimum values Mᵢ are provided as input to the similarity score generator 152 from a human operator, from a separate process executing on the service coordination system 130, and/or from a communication received from a separate computing system. The term Δ(Tᵢ−Cᵢ) is the change in the value of (Tᵢ−Cᵢ) that would be achieved if the cluster pair (A, B) is combined.

In these embodiments, the similarity score generator 152 may implement a process that generates the weights wᵢ and updates the values of the weights wᵢ with each iteration of the clustering process. In a first embodiment, one weight is associated with each similarity component. In each iteration, a weight for a similarity component is increased if there is a relatively large difference (e.g., larger than a threshold difference) between the similarity component and the target value for the similarity component. In contrast, a weight for a similarity component is decreased if there is a relatively small difference (e.g., smaller than a threshold difference) between the similarity component and the target value for the similarity component. As a result, a similarity component that is farther to its target value is assigned a higher weight so that the similarity component can be improved more rapidly. More particularly, the weight for a similarity component may be updated with any of the following techniques: a feedback loop; an objective subgradient; or a Lagrangian multiplier updated by a subgradient. For example, a weight could be updated based on the following formula:

$$Δ {w}_{i} = α \frac{Δ ( {T}_{i} - {C}_{i} )}{max ( {T}_{i} - {C}_{i} , ϵ )} .$$

In this formula, Δ(Tᵢ−Cᵢ) is the change in the value of (Tᵢ−Cᵢ) that was achieved during the previous iteration (or several previous iterations) of the clustering process, a is a constant, and E is a small positive constant (e.g., ϵ∈(0,1]) that is incorporated in the maximum function in the denominator prevent the denominator from having a value of zero or less.

In a second embodiment, two separate weights are associated with each similarity component. In each iteration, the similarity score generator 152 determines, for each similarity component, which of the two weights to apply. The first weight has a positive value and is applied to a similarity component if the similarity component has a value lower than the corresponding target value. The second weight has a negative value and is applied to a similarity component if the similarity component has a value higher than the corresponding target value. In each iteration, the values of both weights are updated based on the methods described above with reference to the first embodiment. Applying different weights based on whether a similarity component is higher or lower than the corresponding target value is advantageous because, for example, it reduces the emphasis on similarity components that have already reached or exceeded their corresponding target levels and allows the iterative clustering process to emphasize other similarity components.

In a third embodiment, two separate weights are associated with each similarity component and each cluster. In other words, the total number of weights maintained by the similarity score generator 152 is twice the product of the number of similarity components and the number of clusters in the most recent iteration. Similar to the weights described above with reference to the second embodiment, one of the two weights has a positive value and the other has a negative value. In each iteration, similarity score generator 152 determines whether to apply a positive weight or a negative weight to each similarity component between each cluster pair based on the same criteria as described above with reference to the second embodiment. Because each weight is associated with a cluster, but a similarity component is generated between a pair of clusters, the similarity score 152 also generates a combined weight based on the weights associated with the two clusters in the pair. For example, if the similarity score generator 152 determines that a positive weight is to be applied to a similarity component between a cluster pair, the similarity score generator 152 may generate the combined weight by computing an average (e.g., an arithmetic mean) of the positive weights associated with the two clusters, or by selecting the larger or smaller of the positive weights associated with the two clusters.

Maintaining a separate pair of weights for each similarity component and each cluster in the manner described above with reference to the third embodiment is advantageous, for example, because different clusters may have different distributions of similarity components. This method of maintaining a pair of weights specific to each similarity component of each cluster allows the similarity score generator 152 to emphasize different similarity components when generating similarity scores between different cluster pairs.

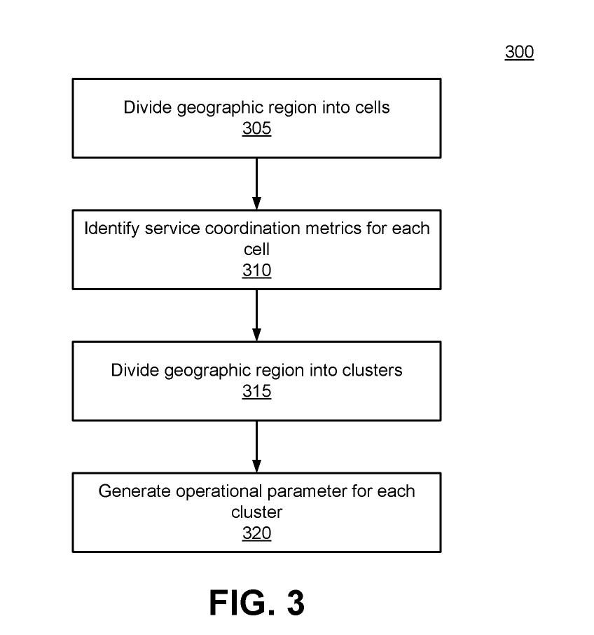

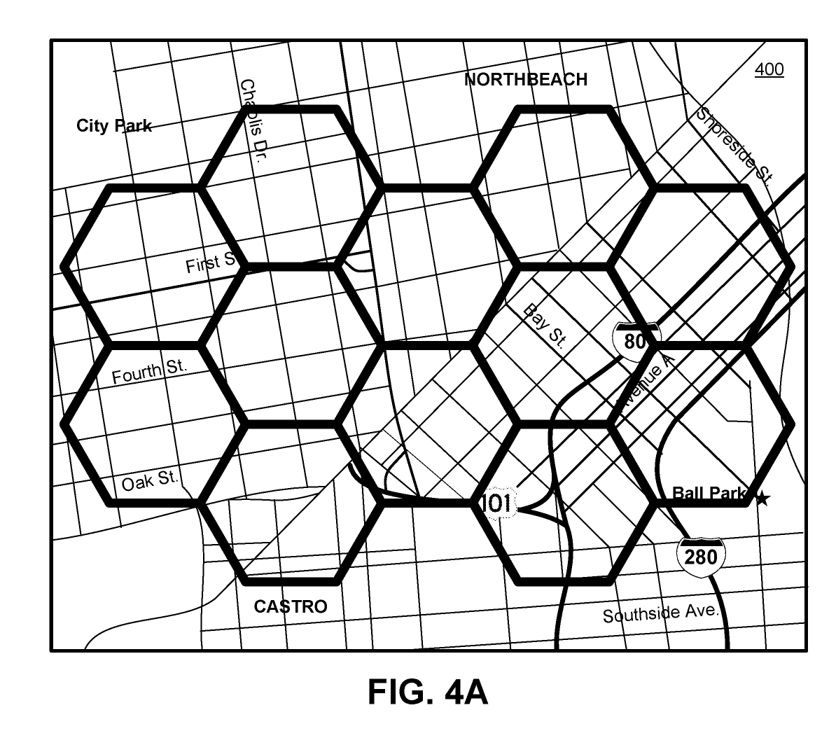

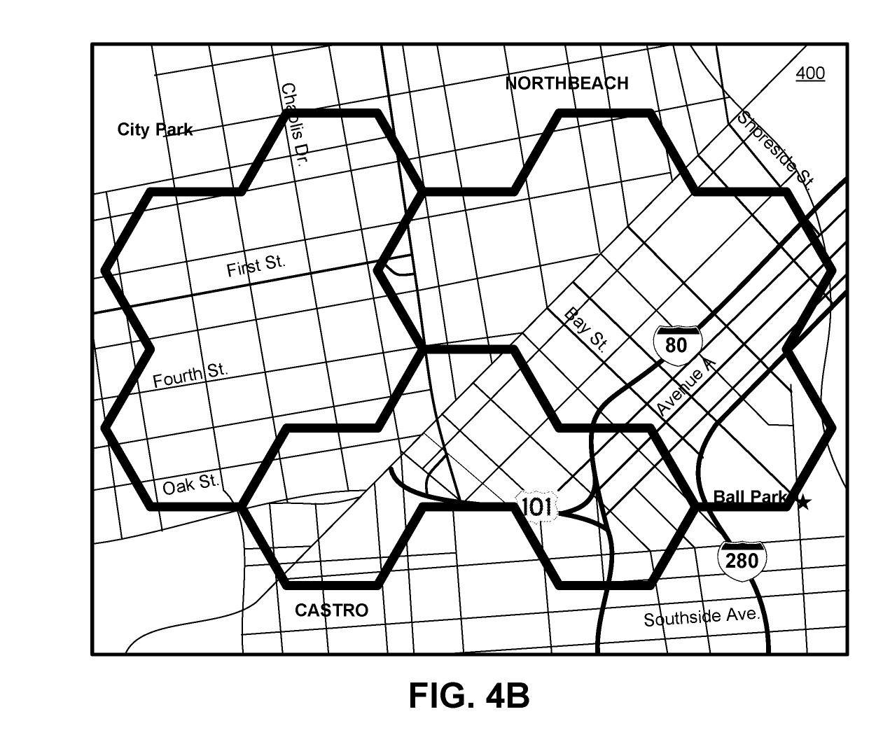

FIG. 3 is a flow chart illustrating a method 300 for generating location-specific operational parameters by dividing a geographic region into a plurality of clusters, according to one embodiment. FIGS. 4A-4B illustrate an example of dividing a geographic region into a plurality of clusters, according to one embodiment. For ease of description, the method 300 shown in FIG. 3 will be discussed below with reference to the example shown in FIGS. 4A-4B.

The cell initialization module 145 divides 305 the geographic region into a plurality of cells. In one embodiment, all of the cells are the same size and shape. For example, the geographic region 400 shown in FIG. 4A is divided into a plurality of hexagonal cells of the same size. The cells may also have different shapes and sizes, such as rectangles, squares, or triangles. In one embodiment, the size, shape, and orientation of the cells are selected to match certain characteristics of the geographic region. For example, a geographic region with a street layout that generally follows a grid pattern (e.g., Manhattan) might be divided into a plurality of rectangular cells that are oriented so that their edges are parallel to most of the streets in the geographic region. As another example, the shape of the cells may be based on existing geographic, political, administrative, or other divisions within the geographic region. For example, a geographic region may be divided so that each state, county, neighborhood, or school district is a separate cell.

The cell initialization module 145 identifies 310 service coordination metrics for each cell. Examples of service coordination metrics include rider price sensitivity, rider-to-rider match probability, provider price sensitivity, and provider-to-rider match probability, all of which are described above with reference to FIG. 2A. Service coordination metrics may be generated based on data stored at the service coordination system 130 that describes past devices' interactions with the service coordination system 130. For example, the service coordination metrics may be generated based on the location-tagged data in the location-based data store 140. Data stored at the service coordination system 130 may also be used directly as service coordination metrics (e.g., without performing any sort of transformation or preprocessing on the data).

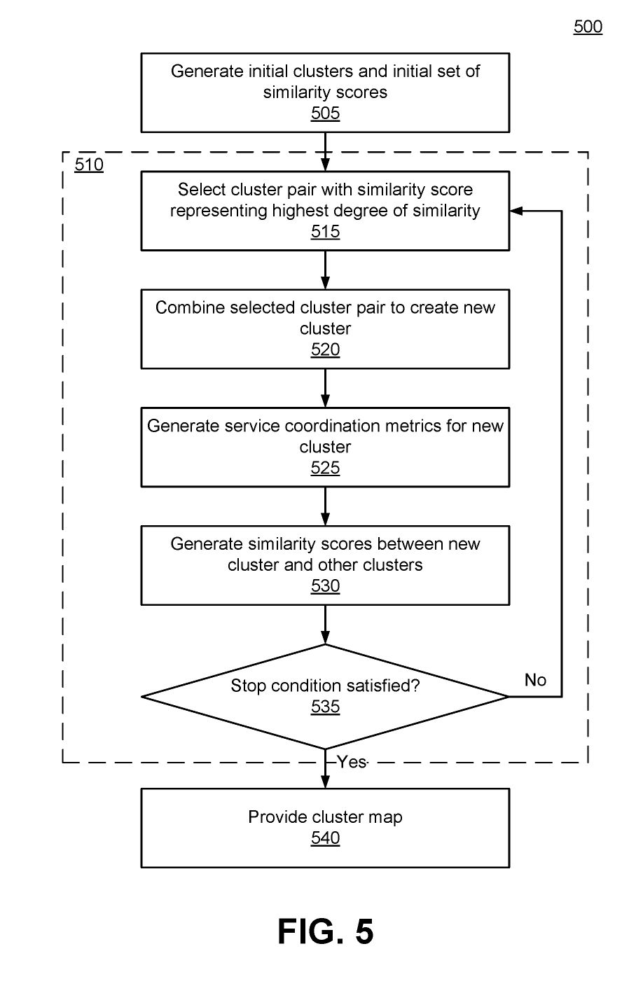

The cluster generation module 150 receives the cells as input and divides 315 the geographic region into clusters and provides a cluster map as output. An example of a cluster map is shown in FIG. 4B. The operation of the cluster generation module 150 is described in further detail with reference to FIG. 5; however, the following paragraphs provide a condensed description of the cluster generation process to provide context for the final step 320 of the method 300 shown in FIG. 3.

The cluster generation module 150 starts by generating an initial set of clusters based on the cells (e.g., by mapping each cell to a separate initial cluster), and the similarity score generator 152 generates an initial set of similarity scores between pairs of the clusters. After generating the initial clusters and similarity scores, the cluster generation module 150 performs an iterative clustering process. With each iteration, the cluster generation module 150 creates a new cluster by joining the cluster pair with the similarity score representing the highest degree of similarity. When joining the cluster pair, the cluster generation module 150 also generates service coordination metrics for the new cluster. Because some components 210 through 225 of the similarity score are based on a difference in a service coordination metric between two clusters, the iterative clustering causes clusters with similar service coordination metrics to be joined.

The similarity score generator 152 may assign varying weights (including a weight of zero) to each of the similarity components 205 through 235 when generating the similarity scores. This allows more weight to be given to similarity components that are especially relevant to the type of operational parameter for which the clusters will be used. For example, one operational parameter is the transportation value for shared trips a cluster (e.g., the price that the service coordination system 130 charges for shared trips); if the cluster map will be used to generate transportation values for shared trips, then the similarity score generator 152 assigns additional weight to the rider price sensitivity component 210 and the rider-to-rider match probability component 215. Another example of an operational parameter is the incentive value for providers (e.g., the payment that the service coordination system 130 offers to providers to provide trips in a cluster); if the cluster map will be used to generate incentive values, then the similarity score generator 152 assigns additional weight to the provider price sensitivity component 220 and the provider-to-rider match probability component 225.

The parameter generation module 165 generates 320 an operational parameter for each cluster. In some embodiments, the operational parameter for a cluster can be generated based at least in part on the service coordination metrics for the cluster. Continuing with the examples provided above, the parameter generation module 165 may generate the transportation value for shared trips in a cluster based at least in part on the rider price sensitivity and the rider-to-rider match probability for the cluster. As another example, the parameter generation module 165 may generate an incentive value for a cluster based at least in part on the provider price sensitivity and the provider-to-rider match probability for the cluster.

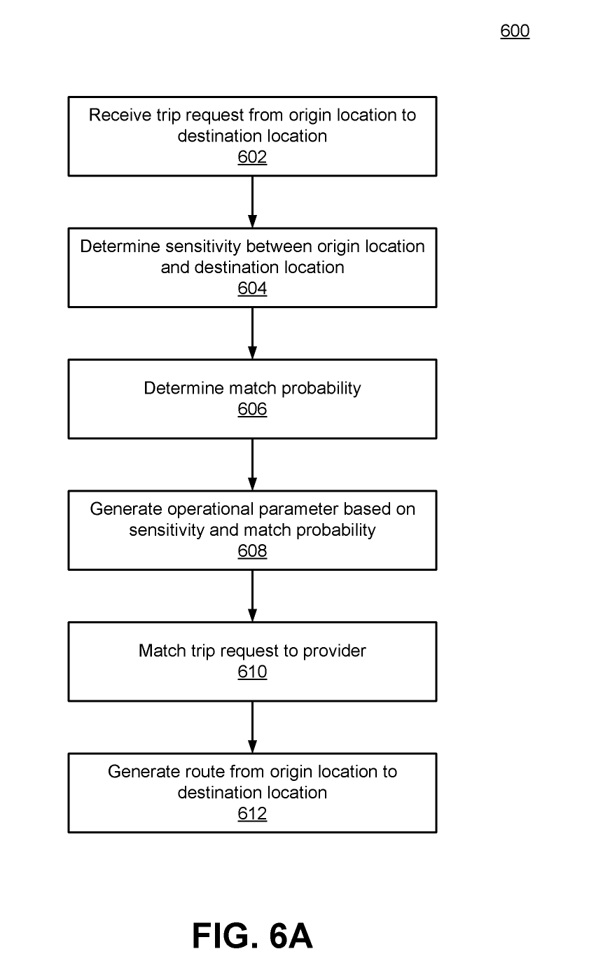

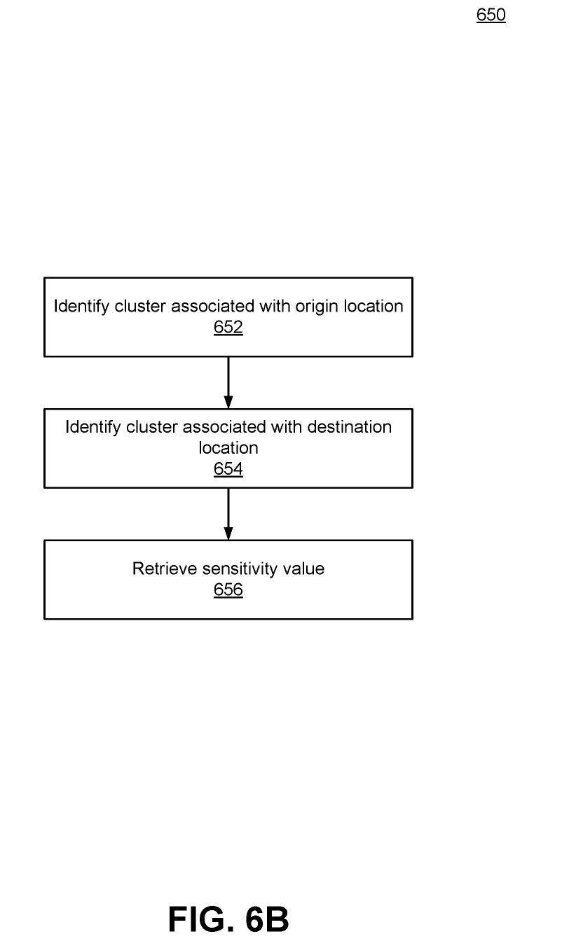

In one embodiment, the parameter generation module 165 generates an operational parameter by calculating a weighted sum of the relevant service coordination metrics. In another embodiment, the operational parameter is generated using a more complicated formula that accounts for the relevant service coordination metrics in addition to a number of other input values. An example of a formula for generating the operational parameter is provided below with reference to FIG. 6A. This method of dividing a geographic region into clusters and generating operational parameters for the clusters is especially advantageous, for example, because the clusters were generated based on similarity scores that gave additional weight to especially relevant similarity components (e.g., similarity components for especially relevant service coordination metrics). This leads to the generation of clusters that combine cells with have similar values for these especially relevant service coordination metrics. As a result, the operational parameter selected for a cluster is more likely to be appropriate for the entire area covered by the cluster.

In other embodiments, the method 300 shown in FIG. 3 may include additional, fewer, or different steps, and the steps shown in FIG. 3 may be performed in a different order. In one embodiment, the step of identifying 310 service coordination metrics for each cell may be omitted in an embodiment where the geographic region is divided 315 into clusters without using any of the similarity components 210 through 225 that are generated based on service coordination metrics. For example, the geographic region 315 may be divided into clusters based solely on the cluster shape component 205.

FIG. 5 is a flow chart illustrating a method 500 for dividing a geographic region into a plurality of clusters, according to one embodiment. The method 500 is one method for generating a plurality of clusters that provide cells having similar service coordination metrics within a cluster. In other embodiments, the method 500 shown in FIG. 5 may include additional, fewer, or different steps, and the steps shown in FIG. 5 may be performed in a different order. In the description of the method 500 provided below, it is assumed, for ease of explanation, that the cluster map 156 is implemented as mapping from each cell to the cluster identifier for the cluster containing the cell. In other embodiments, the cluster map 156 is implemented in a different manner, and the changes to the cluster map 156 that occur during various steps in the method 500 are also implemented in a different manner.

The cluster generation module 150 receives the cells for a geographic region and initializes the cluster map 156 by generating 505 an initial set of clusters based on the cells. For example, the cluster generation module 150 designates each cell as an initial cluster, and the initial version of the cluster map 156 is a mapping from each cell to a different initial cluster identifier. Alternatively, the cluster generation module 150 may generate 505 the initial set of clusters by combining some of the received cells. For example, if the cells have the same size but cover a geographic region that includes both a more densely populated portion and a less densely populated portion (e.g., as indicated by trip request data or by census data received from a third-party system), then the cells covering the less densely populated portion may be combined so that the initial clusters covering the less densely populated portion are larger than the initial clusters covering the more densely populated portion.

The cluster generation module 150 also initializes the association table 154 by generating 505 an initial set of similarity scores between the initial clusters. As described above with reference to FIG. 3, the weights given to the similarity components can be selected (by an algorithm or by user input from an operator of the service coordination system 130) to give more weight to similarity components that are especially relevant to the feature for which the cluster map will be used. The cluster generation module 150 stores each similarity score in the association table 154 in association with the two clusters corresponding to the similarity score.

In one embodiment, the initial set of similarity scores includes a similarity score for every possible pair of initial clusters. In another embodiment, the initial set of similarity scores includes a similarity score for a subset of every possible cluster pair. For example, the initial set of similarity scores includes a similarity score between every pair of adjacent clusters but does not include similarity scores for non-adjacent cluster pairs.

After generating 505 the initial clusters and the initial set of similarity scores, the cluster generation module 150 begins to perform an iterative clustering process 510 to combine the initial clusters into larger clusters. The cluster generation module 150 selects 515 the cluster pair with the similarity score representing the highest degree of similarity. For example, the cluster generation module 150 accesses the association table to identify the similarity score representing the highest degree of similarity and selects the cluster pair associated with the identified similarity score. In an embodiment where a lower similarity score represents a higher degree of similarity, the cluster generation module 150 identifies the lowest similarity score.

The cluster generation module 150 combines 520 the two clusters in the selected cluster pair to create a new cluster. For example, the cluster generation module 150 updates the cluster map 156 to map the cells in the first cluster to the identifier for the second cluster. Alternatively, the cluster generation module 150 maps the cells in both the first cluster and the second cluster to the identifier for a new cluster.

The cluster generation module 150 also generates 525 service coordination metrics for the new cluster. In one embodiment, the service coordination metrics for the new cluster generated 525 by combining the service coordination metrics for the two clusters that were combined. For example, the cluster generation module 150 generates 525 a service coordination metric for the new cluster by calculating a weighted sum of the same service coordination metric for the previous two clusters, where the weights are based on relative sizes of the two clusters. In another embodiment, the service coordination metrics for the new cluster are generated 525 based on historical data (e.g., from the location-based data store) for locations within the new cluster.

The cluster generation module 150 generates 530 similarity scores between the new cluster and at least some of the other clusters (e.g., the clusters other than the two clusters that were combined). In one embodiment, the cluster generation module 150 generates 530 a similarity score between the new cluster and each of the other clusters. In another embodiment, the cluster generation module 150 generates 530 a similarity score between the new cluster and a subset of the other clusters. For example, the cluster generation module 150 generates 530 a similarity score between the new cluster and each cluster adjacent to the new cluster.

The cluster generation module 150 updates the association table 154 to add the new similarity scores along with the associated cluster pairs. The cluster generation module 150 also removes the similarity score for the selected cluster pair, and it also removes similarity scores for any cluster pairs in which one of the two clusters was part of the selected cluster pair. In an embodiment where the association table is a matrix, the removal of these similarity scores is performed by deleting the rows and columns representing the two clusters that were removed, and the addition of the new similarity scores is performed by adding a row and column representing the new cluster and populating the new row and column with the similarity scores.

At the end of an iteration, the cluster generation module 150 determines 535 whether a stop condition has been satisfied. If the stop condition is satisfied, then the iterative process 510 ends, and the cluster generation module 150 provides 540 the cluster map as output. If the stop condition is not satisfied, then the cluster generation module 150 performs another iteration, starting with selecting 515, from the updated association table 154, the cluster pair with the similarity score representing the highest degree of similarity.

The stop condition can be defined in a number of different ways. Examples of stop conditions include: no cluster pair has a similarity score indicating a degree of similarity greater than a threshold degree of similarity (e.g., if a lower similarity score represents a higher degree of similarity, then this stop condition is satisfied if no cluster pair has a similarity score below a threshold value); the total number of clusters is less than a threshold number of clusters; the number of small clusters (e.g., defined as clusters having a size smaller than a threshold size, or defined as clusters having a number of trip requests lower than a threshold number) is less than a threshold number of small clusters; the percentage of cross-cluster trip requests (e.g., trip requests whose pickup location and destination are in different clusters) is below a threshold percentage. In some embodiments, multiple stop conditions can be joined with AND or OR operators to define an aggregate stop condition, and the iterative process 510 ends if the aggregate stop condition is satisfied.

FIG. 6A is a flow chart illustrating a method 600 for generating an operational parameter for a trip request, according to one embodiment. In other embodiments, the method 600 shown in FIG. 6A may include additional, fewer, or different steps, and the steps shown in FIG. 6A may be performed in a different order.

The matching module 135 receives 602 a trip request from one of the rider devices 100 in communication with the service coordination system 130. The trip request specifies an origin location (also referred to as a pickup location) where the ride is to start and a destination location where the ride is to end.

After receiving 602 the trip request, the matching module 135 determines 604 a sensitivity value between the origin location and the destination location in the trip request. Because the method 600 shown in FIG. 6A takes place after a cluster map and service coordination metrics for each cluster have been generated, the matching module 135 can determine 604 the sensitivity value by accessing data in the cluster store 160.

FIG. 6B illustrates an example method 650 for determining 604 the sensitivity value between an origin location and a destination location. For ease of description, the method 650 shown in FIG. 6B will be discussed with reference to an embodiment where the cluster map is a mapping from cells to clusters. In other embodiments, the cluster map may be implemented in a different manner.

The matching module 135 identifies 652 a first cluster associated with the origin location. For example, the matching module 135 identifies the cell containing the origin location and accesses the cluster map to identify the corresponding cluster. Similarly, the matching module 135 identifies 652 a second cluster associated with the second location by identifying the cell containing the destination location and accessing the cluster map to identify the corresponding cluster.

After identifying the clusters, the matching module 135 can access the cluster store 160 to retrieve 656 sensitivity values associated with one or both of the clusters. In one embodiment, the matching module 135 retrieves an origin sensitivity value associated with the first cluster (e.g., a sensitivity value generated based on data for trips originating in the first cluster) and/or a destination sensitivity value associated with the second cluster (e.g., a sensitivity value generated based on data for trips ending in the second cluster). In another embodiment, the matching module 135 retrieves a general sensitivity value associated with the first cluster (e.g., a sensitivity value based on data for trips originating or ending in the first cluster) and/or a general sensitivity value associated with the second cluster (e.g., a sensitivity value based on data for trips originating or ending in the second cluster).

Referring back to FIG. 6A, the matching module 135 also determines 606 a match probability for the trip request. Similar to the method 650 for determining 604 the sensitivity, the match probability may also be determined by accessing data associated with the cluster map in the cluster store 160, and the match probability value may be associated with the cluster containing the origin location or the cluster containing the destination location.

The parameter generation module 165 generates 608 an operational parameter for the trip based on the sensitivity and the match probability. In one embodiment, the operational parameter is generated 608 with the following formula:

$$operationalParameter ( M , S ) = 0.5 + 0.5 \frac{1}{1 + {e}^{α M + β S}} .$$

In this formula, M represents match probability, S represents sensitivity, and α and β are constants. This formula can be used to generate incentive values and/or transportation values (e.g., two examples of operational parameters that are described in other portions of this disclosure). For instance, if this formula is used to generate incentive values, then M represents the provider-to-rider match probability and S represents the provider price sensitivity. Similarly, if this formula is used to generate transportation values, then M represents the rider-to-rider match probability and S represents the rider price sensitivity.

The matching module 135 matches 610 the trip request to a provider. As described above with respect to FIG. 1, the matching is performed by selecting a provider from a set of candidate providers, sending an assignment request to the selected provider, and receiving an indication that the selected provider has accepted the assignment request. The matching module 135, the provider device 110 associated with the selected provider, or a third-party routing system generates 612 a route from the origin location to the destination location.

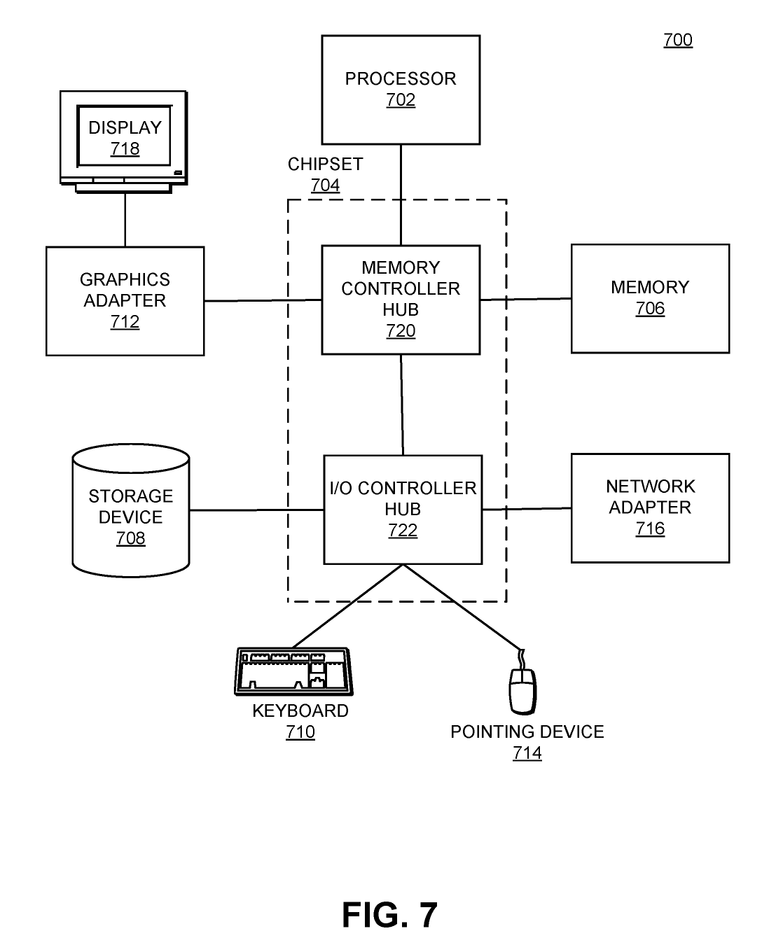

FIG. 7 is a high-level block diagram illustrating physical components of a computer 700 used as part or all of the service coordination system 130, rider device 100, or provider device 110 from FIG. 1, according to one embodiment. Illustrated are at least one processor 702 coupled to a chipset 704. Also coupled to the chipset 704 are a memory 706, a storage device 708, a graphics adapter 712, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, such as a hard drive, compact disk read-only memory (CD-ROM), DVD, or a solid-state memory device. The memory 706 holds instructions and data used by the processor 702. The graphics adapter 712 displays images and other information on the display 718. The network adapter 716 couples the computer 700 to a local or wide area network.

As is known in the art, a computer 700 can have different and/or other components than those shown in FIG. 7. In addition, the computer 700 can lack certain illustrated components. In one embodiment, a computer 700, such as a host or smartphone, may lack a graphics adapter 712, and/or display 718, as well as a keyboard or external pointing device. Moreover, the storage device 708 can be local and/or remote from the computer 600 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. For instance, a computing device coupled to a data storage device storing the computer program can correspond to a special purpose computing device. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for dividing a geographic region into a plurality of clusters, the method comprising:
dividing the geographic region into a plurality of cells, each cell covering a geographic area and having one or more service coordination metrics, each service coordination metric describing at least one of: a type of rider behavior in the geographic area and a type of provider behavior in the geographic area;
identifying a plurality of clusters, each cluster having at least one cell and each cell of the plurality of cells belonging to one cluster;
for at least two pairs of clusters in the plurality of clusters, generating a similarity score between the pair of clusters by combining a plurality of similarity components, wherein the similarity score represents an overall degree of similarity between the pair of clusters, and wherein at least one of the similarity components represents a degree of similarity in a service coordination metric between the pair of cells;
until a stop condition is satisfied, performing an iterative clustering process comprising:
selecting a pair of clusters, the selected pair of clusters having a similarity score representing the highest degree of similarity among the generated similarity scores,
combining the selected pair of clusters to create a new cluster,
generating one or more service coordination metrics for the new cluster based on the one or more service coordination metrics for the selected pair of clusters, and
generating one or more new similarity scores, each new similarity score generated between the new cluster and one other cluster, and each new similarity score generated based on the one or more service coordination metrics for the new cluster and the one or more service coordination metrics for the other cluster; and
responsive to detecting that the stop condition is satisfied, providing a cluster map associating each cell with a cluster.

2. The method of claim 1, wherein each cell covers a geographic area of the same size.

3. The method of claim 1, wherein a similarity score is generated for each pairing of clusters in the plurality of clusters.

4. The method of claim 1, wherein a similarity score is generated for each pairing of adjacent clusters in the plurality of clusters.

5. The method of claim 1, wherein one of the service coordination metrics is a provider sensitivity metric representing a likelihood that a provider will provide a transportation service in the cell in return for a given incentive value, and wherein one of the similarity components is a provider sensitivity component representing a degree of similarity between the provider sensitivity metric of a first cluster in the pair of clusters and the provider sensitivity metric of a second cluster in the pair of clusters.

6. The method of claim 1, wherein one of the service coordination metrics is a rider sensitivity metric representing a likelihood that a rider in the cell will request a transportation service at a given value for the transportation service, and wherein one of the similarity components is a rider sensitivity component representing a degree of similarity between the rider sensitivity metric of a first cluster in the pair of clusters and the rider sensitivity metric of a second cluster in the pair of clusters.

7. The method of claim 1, wherein one of the similarity components is a cluster shape component generated based on a length of a shared edge between the pair of adjacent clusters and the sizes of the clusters in the pair.

8. The method of claim 1, wherein one of the similarity components is a correlation component representing a strength of a correlation between a service coordination metric of a first cluster in the cluster pair and a service coordination metric of a second cluster in the cluster pair.

9. The method of claim 1, wherein combining a plurality of similarity components comprises generating a plurality of weights, each of the weights associated with one of the plurality of similarity components, wherein one or more of the plurality of weights are updated after an iteration of the iterative clustering process.

10. The method of claim 1, wherein the stop condition is based at least in part on whether at least one of generated similarity scores indicates a degree of similarity greater than a threshold degree of similarity

11. The method of claim 1, wherein the stop condition is based at least in part on whether the total number of clusters is smaller than a threshold number of clusters.

12. The method of claim 1, wherein the stop condition is based at least in part on whether the number of clusters meeting a definition for small cluster is smaller than a threshold number of small clusters.

13. The method of claim 12, wherein the definition for small cluster is a cluster covering a geographic area smaller than a threshold geographic area.

14. The method of claim 12, wherein the definition for small cluster is a cluster having number of trip requests smaller than a threshold number of trip requests.

15. A method for dividing a geographic region into a plurality of clusters, the method comprising:
dividing the geographic region into a plurality of cells, each cell covering a geographic area;
identifying a plurality of clusters, each cluster having at least one cell and each cell belonging to one cluster;
for each pair of adjacent clusters in the plurality of clusters, generating a similarity score between the pair of adjacent clusters by combining a plurality of similarity components, wherein one of the similarity components is a cluster shape component generated based on a length of a shared edge between the pair of adjacent clusters and the sizes of the clusters in the pair;
until a stop condition is satisfied, performing an iterative clustering process comprising:
selecting a pair of adjacent clusters, the selected pair of adjacent clusters having a similarity score representing the highest degree of similarity among the generated similarity scores,
combining the selected pair of clusters to create a new cluster, and
generating one or more new similarity scores, each new similarity score generated between the new cluster and one other cluster; and
responsive to detecting that the stop condition is satisfied, providing a cluster map associating each cell with a cluster.

16. The method of claim 15, wherein each cell covers a geographic area of the same size.

17. The method of claim 15, wherein the stop condition is based at least in part on whether at least one of generated similarity scores indicates a degree of similarity greater than a threshold degree of similarity.

18. The method of claim 15, wherein the stop condition is based at least in part on whether the total number of clusters is smaller than a threshold number of clusters.

19. The method of claim 15, wherein the stop condition is based at least in part on whether the number of clusters meeting a definition for small cluster is smaller than a threshold number of small clusters.

20. The method of claim 19, wherein the definition for small cluster is a cluster covering a geographic area smaller than a threshold geographic area.

21. The method of claim 19, wherein the definition for small cluster is a cluster having number of trip requests smaller than a threshold number of trip requests.

22. A method for further clustering a geographic region, the geographic region divided into a plurality of clusters, each cluster having one or more service coordination metrics, and at least two pairs of clusters in the geographic region having a similarity score representing an overall degree of similarity between the pair of clusters, the method comprising:
selecting a pair of clusters, the selected pair of clusters having a similarity score representing the highest degree of similarity among the similarity scores;
combining the selected pair of clusters to create a new cluster;
generating one or more service coordination metrics for the new cluster based on the one or more service coordination metrics for the selected pair of clusters; and
generating one or more new similarity scores, each new similarity score generated between the new cluster and one other cluster, and each new similarity score generated based on the one or more service coordination metrics for the new cluster and the one or more service coordination metrics for the other cluster.
